(19) United States
(12) Patent Application Publication
(10) Pub. No.: US 2014/0188632 A1
(43) Pub. Date: Jul. 3, 2014

(54) ALLOCATION OF CONTENT INVENTORY UNITS

(71) Applicant: Google Inc., (US)

(72) Inventor: Gagan Goel, New York, NY (US)

(73) Assignee: Google Inc., Mountain View, CA (US)

(21) Appl. No.: 13/766,473

(22) Filed: Feb. 13, 2013

Related U.S. Application Data
(60) Provisional application No. 61/747,627, filed on Dec. 31, 2012.

(51) Int. Cl. G06Q 30/02

(52) U.S. Cl. CPC G06Q 30/0275
USPC 705/14.71

(57) ABSTRACT

This specification describes technologies relating to selection and delivery of online content. In general, one aspect of the subject matter described in this specification can be embodied in methods that include receiving a request for allocation of a content inventory unit and a first reserve price. A second price may be determined based in part on the first reserve price and a difference between a highest sharing fraction in a range and a lowest sharing fraction in the range. Adjusted bids may be determined based on received bids and the highest sharing fraction. The methods may further include allocating the content inventory unit to a buyer based on the adjusted bids and the second price, determining a payment to the seller as a maximum of an auction price and the first reserve price, and determining a payment from the buyer based on the auction price and the highest sharing fraction.

### CROSS-REFERENCE TO RELATED APPLICATION

Priority is hereby claimed to U.S. Provisional Application No. 61/747,627, which was filed on Dec. 31, 2012. The contents of U.S. Provisional Application No. 61/747,627 are hereby incorporated by reference into this disclosure.

### BACKGROUND

This disclosure relates to the selection and delivery of online content.

Online content can include web pages and advertisements displayed with the web pages. Content publishers have space that they sell to advertisers or other content providers directly or through intermediaries, such as brokers. Some of a publisher's available space may be sold through a content inventory marketplace. This content inventory market is a spot market that connects publishers with content providers (e.g., advertisers) in response to a request for content from a user. The publisher may communicate with one or more content providers or market intermediaries in an attempt to sell the space in time to serve content associated with the buyer.

Some auctions have a property called truthfulness. A truthful auction creates incentives for each bidder to reveal their private information by bidding their true valuation for the thing that is being auctioned. In other words, for each bidder, making a bid equal to their true valuation is the dominant strategy to maximize their individual utility. For example, some second-price auctions have the truthfulness property.

### SUMMARY

This specification describes technologies relating to selection and delivery of online content items. In general, one aspect of the subject matter described in this specification can be embodied in a method that includes receiving a request for allocation of a content inventory unit and receiving a first price for the content inventory unit, where the first price is a minimum payment that a seller will accept for allocation of the content inventory unit. The method may further include determining a second price based in part on the first price and based in part on a difference between a highest sharing fraction in a range and a lowest sharing fraction in the range. The method may further include receiving one or more bids for the content inventory unit and determining one or more adjusted bids based on the one or more bids and the highest sharing fraction. The method may further include comparing at least one of the one or more adjusted bids to the second price and allocating the content inventory unit to a buyer based in part on the one or more adjusted bids and the second price. The method may further include determining an auction price as a maximum of a set including the second price and at least one of the one or more adjusted bids. The method may further include determining a payment to the seller as a maximum of the first price and the auction price. The method may further include determining a payment from the buyer based on the auction price and the highest sharing fraction. The method may further include transmitting data reflecting the allocation of the content inventory unit to the buyer.

In general, one aspect of the subject matter described in this specification can be embodied in a system that includes a network interface configured to receive a request for allocation of a content inventory unit. The system may include a network interface configured to receive a first price for the content inventory unit, where the first price is a minimum payment that a seller will accept for allocation of the content inventory unit. The system may include a means for determining a second price based in part on the first price and based in part on a difference between a highest sharing fraction in a range and a lowest sharing fraction in the range. The system may include a network interface configured to receive one or more bids for the content inventory unit. The system may include a module configured to determine one or more adjusted bids based on the one or more bids and the highest sharing fraction. The system may include a module configured to comparing at least one of the one or more adjusted bids to the second price. The system may include a module configured to allocate the content inventory unit to a buyer based in part on the one or more adjusted bids and the second price. The system may include a module configured to determine an auction price as a maximum of a set including the second price and at least one of the one or more adjusted bids. The system may include a module configured to determine a payment to the seller as a maximum of the first price and the auction price. The system may include a module configured to determine a payment from the buyer based on the auction price and the highest sharing fraction. The system may include a network interface configured to transmit data reflecting the allocation of the content inventory unit to the buyer.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including receiving a request for allocation of a content inventory unit and receiving a first price for the content inventory unit, where the first price is a minimum payment that a seller will accept for allocation of the content inventory unit. The operations may further include determining a second price based in part on the first price and based in part on a difference between a highest sharing fraction in a range and a lowest sharing fraction in the range. The operations may further include receiving one or more bids for the content inventory unit. The operations may further include determining one or more adjusted bids based on the one or more bids and the highest sharing fraction. The operations may further include comparing at least one of the one or more adjusted bids to the second price and allocating the content inventory unit to a buyer based in part on the one or more adjusted bids and the second price. The operations may further include determining an auction price as a maximum of a set including the second price and at least one of the one or more adjusted bids. The operations may further include determining a payment to the seller as a maximum of the first price and the auction price. The operations may further include determining a payment from the buyer based on the auction price and the highest sharing fraction. The operations may further include transmitting data reflecting the allocation of the content inventory unit to the buyer.

In general, one aspect of the subject matter described in this specification can be embodied in a non-transient computer readable media storing software including instructions executable by a processing device that upon such execution cause the processing device to perform operations that include receiving a request for allocation of a content inventory unit and receiving a first price for the content inventory unit, where the first price is a minimum payment that a seller will accept for allocation of the content inventory unit. The operations may further include determining a second price based in part on the first price and based in part on a difference between a highest sharing fraction in a range and a lowest sharing fraction in the range. The operations may further include receiving one or more bids for the content inventory unit. The operations may further include determining one or more adjusted bids based on the one or more bids and the highest sharing fraction. The operations may further include comparing at least one of the one or more adjusted bids to the second price and allocating the content inventory unit to a buyer based in part on the one or more adjusted bids and the second price. The operations may further include determining an auction price as a maximum of a set including the second price and at least one of the one or more adjusted bids. The operations may further include determining a payment to the seller as a maximum of the first price and the auction price. The operations may further include determining a payment from the buyer based on the auction price and the highest sharing fraction. The operations may further include transmitting data reflecting the allocation of the content inventory unit to the buyer.

In general, one aspect of the subject matter described in this specification can be embodied in a method that includes receiving a request for allocation of a content inventory unit and receiving a first price for the content inventory unit, where the first price is a minimum payment that a seller will accept for allocation of the content inventory unit. The method may further include determining a second price based in part on the first price and based in part on a difference between a highest sharing fraction in a range and a lowest sharing fraction in the range. The method may further include receiving a first bid for the content inventory unit and determining a first adjusted bid based on the first bid and the highest sharing fraction. The method may further include comparing the first adjusted bid to the second price and allocating the content inventory unit to a buyer based in part on the first adjusted bid and the second price. The method may further include determining an auction price based in part on the second price. The method may further include determining a payment to the seller as a maximum of the first price and the auction price. The method may further include determining a payment from the buyer based on the auction price and the highest sharing fraction. The method may further include transmitting data reflecting the allocation of the content inventory unit to the buyer.

In general, one aspect of the subject matter described in this specification can be embodied in a system that includes a network interface configured to receive a request for allocation of a content inventory unit. The system may include a network interface configured to receive a first price for the content inventory unit, where the first price is a minimum payment that a seller will accept for allocation of the content inventory unit. The system may include a means for determining a second price based in part on the first price and based in part on a difference between a highest sharing fraction in a range and a lowest sharing fraction in the range. The system may include a network interface configured to receive a first bid for the content inventory unit. The system may include a module configured to determine a first adjusted bid based on the first bid and the highest sharing fraction. The system may include a module configured to compare the first adjusted bid to the second price. The system may include a module configured to allocate the content inventory unit to a buyer based in part on the first adjusted bid and the second price. The system may include a module configured to determine an auction price based in part on the second price. The system may include a module configured to determine a payment to the seller as a maximum of the first price and the auction price. The system may include a module configured to determine a payment from the buyer based on the auction price and the highest sharing fraction. The system may include a network interface configured to transmit data reflecting the allocation of the content inventory unit to the buyer.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including receiving a request for allocation of a content inventory unit and receiving a first price for the content inventory unit, where the first price is a minimum payment that a seller will accept for allocation of the content inventory unit. The operations may further include determining a second price based in part on the first price and based in part on a difference between a highest sharing fraction in a range and a lowest sharing fraction in the range. The operations may further include receiving a first bid for the content inventory unit and determining a first adjusted bid based on the first bid and the highest sharing fraction. The operations may further include comparing the first adjusted bid to the second price and allocating the content inventory unit to a buyer based in part on the first adjusted bid and the second price. The operations may further include determining an auction price based in part on the second price. The operations may further include determining a payment to the seller as a maximum of the first price and the auction price. The operations may further include determining a payment from the buyer based on the auction price and the highest sharing fraction. The operations may further include transmitting data reflecting the allocation of the content inventory unit to the buyer.

In general, one aspect of the subject matter described in this specification can be embodied in a non-transient computer readable media storing software including instructions executable by a processing device that upon such execution cause the processing device to perform operations that include receiving a request for allocation of a content inventory unit and receiving a first price for the content inventory unit, where the first price is a minimum payment that a seller will accept for allocation of the content inventory unit. The operations may further include determining a second price based in part on the first price and based in part on a difference between a highest sharing fraction in a range and a lowest sharing fraction in the range. The operations may further include receiving a first bid for the content inventory unit and determining a first adjusted bid based on the first bid and the highest sharing fraction. The operations may further include comparing the first adjusted bid to the second price and allocating the content inventory unit to a buyer based in part on the first adjusted bid and the second price. The operations may further include determining an auction price based in part on the second price. The operations may further include determining a payment to the seller as a maximum of the first price and the auction price. The operations may further include determining a payment from the buyer based on the auction price and the highest sharing fraction. The operations may further include transmitting data reflecting the allocation of the content inventory unit to the buyer.

These and other embodiments can each optionally include one or more of the following features. Determining the second price may include multiplying the first price by one minus the difference between the highest sharing fraction and the lowest sharing fraction. Determining the one or more adjusted bids may include multiplying the one or more bids by one minus the highest sharing fraction. The auction price may be determined as a maximum of a set including the second price and the one or more adjusted bids with the exception of a highest of the one or more adjusted bids. Determining the payment from the buyer may include dividing the auction price by one minus the highest sharing fraction. The content inventory unit may be allocated to the buyer based on the results of a truthful auction. The lowest sharing fraction may be determined based in part on a minimum cost associated with an auction platform. Information reflecting a content item supplied by the buyer may be transmitted to a user device. One or more additional bids may be received for the content inventory unit. One or more additional adjusted bids may be determined based on the one or more additional bids and a first sharing fraction associated with the one or more additional bids. The first adjusted auction price may be compared to the one or more additional adjusted auction prices. Determining the auction price may include determining a maximum of the second price and the one or more additional adjusted bids. The lowest sharing fraction may be determined based in part on a fixed sharing fraction for an auction platform. A payment to an operator of the auction platform may be determined based on the fixed share fraction. A payment to a party that submitted one of the one or more bids on behalf of the buyer may be determined as the payment from the buyer minus the payment to the seller and the payment to the operator of the auction platform.

Particular embodiments of the subject matter described in this disclosure can be implemented to realize none, one or more of the following advantages. Content inventory units that would not otherwise be allocated through an auction platform or an advertising network may be allocated to produce some revenue by dynamically lowering a revenue share of the auction platform and/or advertising network. The dynamic reduction of a sharing fraction may be implemented while preserving a truthfulness property for content inventory unit auctions that run on an auction platform. Content inventory unit inventory may be allocated to a buyer that may enhance revenue for the publisher. The number of content inventory units successfully allocated through an online content inventory unit auction platform may be increased compared to an auction platform that uses a single fixed sharing fraction. Revenue realized by an online content inventory unit auction platform may be increased compared to an auction platform that uses a single fixed sharing fraction. Revenue realized by an advertising network may be increased compared to an advertising network that uses a single fixed sharing fraction.

The details of one or more embodiments of the subject matter described in this disclosure are set forth in the accompanying drawings and the description below. Other features, aspects, and advantages will become apparent from the description, the drawings, and the claims.

### BRIEF DESCRIPTION OF THE DRAWINGS

FIG. 1 is a block diagram of an example online environment.

FIG. 2 is block diagram of an example spot market for content inventory.

FIG. 3 is a flowchart of an example process for allocating a content inventory unit to a buyer in response to a user request for content.

FIG. 4 is a flowchart of an example process for allocating a content inventory unit to a buyer in response to a user request for content.

FIG. 5 is block diagram of an example computer system that can be used to facilitate the selection and delivery of content.

### DETAILED DESCRIPTION

Online content publishers try to derive as much revenue as they can from their available inventory (e.g. content inventory units in which advertisements or other content items may be presented). Publishers sell some of their inventory in guaranteed deals to individual content providers. The rest they generally provide to a number of different Market-Based Buyers (“MBBs”), who in turn sell to the highest bidder and pay the publisher some proportion of the received price. For example, MBBs can be yield managers or exchanges.

One type of MBB is an auction platform. An auction platform can allocate a content inventory unit by accepting bids from one or more potential buyers (e.g., advertisers, advertising networks, or other demand-side platforms), selecting a winning bid, and determining a buyer's price for the content inventory unit based on a set of rules called an auction mechanism. In some implementations, the auction mechanism may be designed to be truthful, in the sense that it incentivizes potential buyers to bid their true valuation of the content inventory unit. For example, a second-price auction may create an incentive for a potential buyer to bid their true valuation of a content inventory unit. When a content inventory unit is allocated to a winner of one of these auctions, the winning buyer pays a price determined by the auction mechanism and this revenue may be shared by the publisher, an operator of the auction platform, and/or an operator of an advertisement network that enters a bid on behalf of the winning bidder.

A sharing fraction is a value less than one that may be used to determine a portion of the revenue from a content inventory unit allocation that will be paid to an entity participating in the allocation of the content inventory unit (e.g., a publisher of the content slot in which the content inventory unit occurs, an operator of the auction platform, or an operator of an advertisement network that facilitates the allocation).

A reserve price may be declared by a seller (e.g., a publisher) when submitting a request for allocation of a content inventory unit through an auction platform. The reserve price declared by the seller may be the minimum amount of revenue that the seller will accept in return for the allocation of the content inventory unit. If no bid exceeds the reserve price, then the content inventory unit may not be allocated through the auction platform (or equivalently, the content inventory unit is allocated back to the seller). In this case, the auction platform may receive zero revenue.

When running an auction for a content inventory unit, the auction mechanism may adjust the bids received based on a sharing fraction specifying a portion of the revenues that will be retained by the auction platform. The adjusted bids may be compared to the seller's declared reserve price to ensure that any allocation to a buyer results in sufficient revenue to make a payment of at least the seller's declared reserve price and also pay the operator of the auction platform the revenues determined by its sharing fraction. Where the sharing fraction for the auction platform is fixed, this may prevent content inventory unit allocation from occurring when the winning bid is above the declared reserve price, but the adjusted winning bid is below the declared reserve price.

In some implementations, an auction platform dynamically varies its sharing fraction within a range of acceptable values. By dynamically varying the sharing fraction, the auction platform may successfully allocate more content inventory units. In some implementations, the sharing fraction is changed by determining a second reserve price that is discounted by a factor that depends on the difference between the highest sharing fraction in the range and the lowest sharing fraction in the range. Bids may be adjusted by discounting the bids based on the highest sharing fraction in the range. Adjusted bids may be compared to the second reserve price and an allocation may proceed if the winning adjusted bid is above the second reserve price. The seller (e.g., the publisher) of the content inventory unit may be paid the maximum of its declared reserve price and the adjusted auction price determined by the auction mechanism using the second reserve price. The auction platform may retain the remainder of the revenues paid by the buyer, which may correspond to a sharing fraction within the required range of sharing fractions. In some implementations, the sharing fraction is dynamically varied in manner that preserves the truthful property of an auction mechanism.

For example, suppose a website server receives a request from a user device for a webpage including at least one content slot. The website seeks to increase its revenue by finding an advertiser willing to pay the highest price for serving its advertisement in this content slot (e.g., buying the content inventory unit). The website may then submit a request for allocation of the content inventory unit to an auction platform in this spot market, along with a reserve price of $1 that specifies the minimum revenues that the publisher of the website will accept in exchange for allocation of the content inventory unit. The auction platform may determine a second reserve price for this content inventory unit based on the declared reserve price received from the website and a difference between a highest sharing fraction and a lowest sharing fraction in a range of sharing fractions for the auction platform. For example, if the sharing fraction varies from 5% to 20%, the second reserve price may be determined as $1/(1−(0.2−0.05))=$0.85. Bids may be received from a set of potential buyers of the content inventory unit (e.g., advertisers). The bids may be adjusted for comparison to the second reserve price by discounting the bids by a factor that depends on the highest sharing fraction. For example, the bids may be multiplied by (1−0.2)=0.8. Suppose two bids $1.15 and $1.10 are received. Note that if a fixed sharing ratio of 20% were used, the allocation of this content inventory unit would be prevented. Instead, the adjusted bids ($0.92 and $0.88) are compared to the second reserve price of $0.85. Since the winning adjusted bid ($0.92) is higher than the second reserve price the content inventory unit is successfully allocated to the corresponding buyer. The auction price may be determined using a second-price auction mechanism as the maximum of the second reserve price and the second highest adjusted bid, in this case $0.88. The price paid by the highest bidder (the winner) for the content inventory unit may be the auction price scaled up by a factor that depends on the maximum sharing fraction for the auction platform, e.g., $0.88/(1−0.2)=$1.10. The publisher of the website may be paid the maximum of its declared reserve price and the auction price, in, this example, $1.00, The remainder of the revenue from allocation of the content inventory unit ($1.10−$1.00=$0.10) is retained by the operator of the auction platform, resulting in a dynamic sharing fraction of approximately 9%. The winner of the auction is allocated the content inventory unit and the winner's advertisement is presented to a user through display on the user device in the content slot within the requested webpage.

In some implementations, another market intermediary (e.g., an advertisement network) may coordinate with an auction platform to dynamically vary the sharing fraction that it charges to buyers using its service to bid on content inventory units allocated in the auction platform. For example, dynamically varying the sharing fraction of an advertisement network may allow more content inventory units to be allocated through that advertisement network and through an advertisement network that facilitates the dynamic revenue sharing by the advertisement network. In some implementations, a second reserve price is determined based on a seller's declared reserve price and a difference between a highest sharing fraction and a lowest sharing fraction in a range of sharing fractions corresponding to the combined revenue share of the auction platform and the advertisement network. When an auction is run to allocate a content inventory unit, a bid from the advertisement network may be adjusted based on the highest sharing fraction in the range and the adjusted bid may be compared to the second reserve price. Other competing bids may be adjusted by different sharing ratios that apply to those bids and thus adjusted bids may be compared to a different reserve price (e.g., the declared reserve price). The content inventory unit may be allocated to the advertisement network and its buyer if the adjusted advertisement network bid is above the second reserve price and either the adjusted advertisement network bid is the highest adjusted or all the other adjusted bids are below their respective reserve prices.

A content item is any data that can be provided over a network. For example, an advertisement, including a link to a landing page is a content item. The processes described below are illustratively applied to content items that are advertisements provided in response to a request from an online resource, but the processes are also applicable to other content items provided over a network.

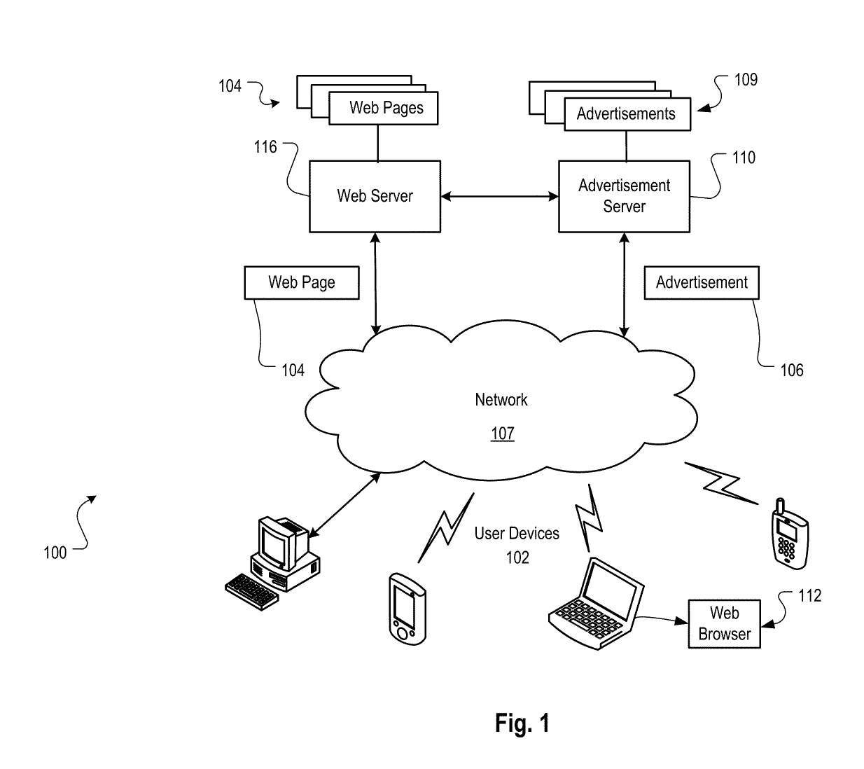

FIG. 1 is a block diagram of an example online environment 100 that facilitates the serving of content items for display on user devices 102. For example, content items can include web pages 104 and advertisements 106 (e.g., advertisements related to the web pages 104).

Web pages 104 and advertisements 106 can be provided to user devices 102 through a network 107 (e.g. a wide area network, local area network, the Internet, or any other public or private network, or combination of both.) User devices 102 can connect to a web server 116 (or an advertisement server 110) through the network 107 using any device capable of communicating in a computer network environment and displaying retrieved information. Example user devices 102 include a web-enabled handheld device, a mobile telephone or smartphone, tablet device, a set top box, a game console, a personal digital assistant, a navigation device, or a computer.

Web pages 104 can be provided by a web server 116 for display on a user device 102, and advertisements 106 can be provided by the advertisement server 110 for display on the user device 102. In some implementations, the advertisements 106 are provided directly to the web server 116 by the advertisement server 110, and the web server 116 then provides the advertisements 106 to the user devices 102 in association with one or more particular web pages 104, e.g., web pages which are related to the advertisements 106. In some implementations, the web server 116 queries the advertisement server 110 for advertisements 106 related to one or more particular web pages 104, and the advertisement server 110 evaluates a pool 109 of advertisements and chooses one or more advertisements 106 that are related to the web pages 104, e.g. advertisements that pertain to subject matter referenced by or described within the web pages 104. The advertisements 106 can be displayed with the web page 104 on a web browser 112 of a user device 102. The advertisements 106 can also be requested as part of the delivery of a web page 104 in response to a user device 102 requesting the web page 104 from a web server 116.

The content served by online publishers can take many other forms. For example, content items may include one or more media formats, including web pages, portions of web pages, banners, text, HTML page address pointers, hypertext, audio content, visual content, buttons, pop-up windows, placement within sponsored search listings, streaming media (including video and/or audio), and combinations thereof. Ads are content that advertisers may pay to have paired and delivered with other publisher content to users or consumers. Ads can be in any of the media formats that other content occurs in. While reference is made herein to the delivery of ads, other forms of content including other forms of sponsored content can be delivered by the systems and methods proposed.

When a user requests online content (e.g., a web page or another online resource), content requests can be initiated to request content from a content publisher for presentation on a user device. For example, content publishers can include publishers of web sites or search engines that are publishing search results responsive to a query. One or more additional content items (e.g., ads) can be provided along with the requested content. As a result, the presented content can include, for example, text, images, audio, video, advertisements (or ads) or other content selected for presentation to the user. In response to each content request received, content can be served, including one or more ads. Ads may advertise a product or service, on behalf of an advertiser, in a format that may entice an action (e.g., clicking, buying, etc.) by the user who sees the ad.

A content inventory unit is a unit of content (e.g., ad) space inventory. For example, a content inventory unit occurs when an ad is delivered, usually with accompanying content, to a user. A content inventory unit may have a number of characteristics, such as characteristics of the requested content to be paired with the secondary content (e.g., ad), the timing of the user request and corresponding delivery of content, and characteristics of the user who requested the content, such as demographic information and geographic location. A single user request for content may initiate multiple content inventory units. For example, as user request for a web page may allow a publisher to deliver multiple ads that are displayed in different locations within the rendered web page. In some implementations, a system can record an indication of each delivered content inventory unit, such as for accounting purposes.

A publisher may operate a server, such as web server 116, for delivering content to users. The publisher may also operate an ad server, such as advertisement server 110, or may direct users to ads served from ad servers operated by other entities. When a publisher has content inventory, it often seeks to sell that inventory in real time on a spot market.

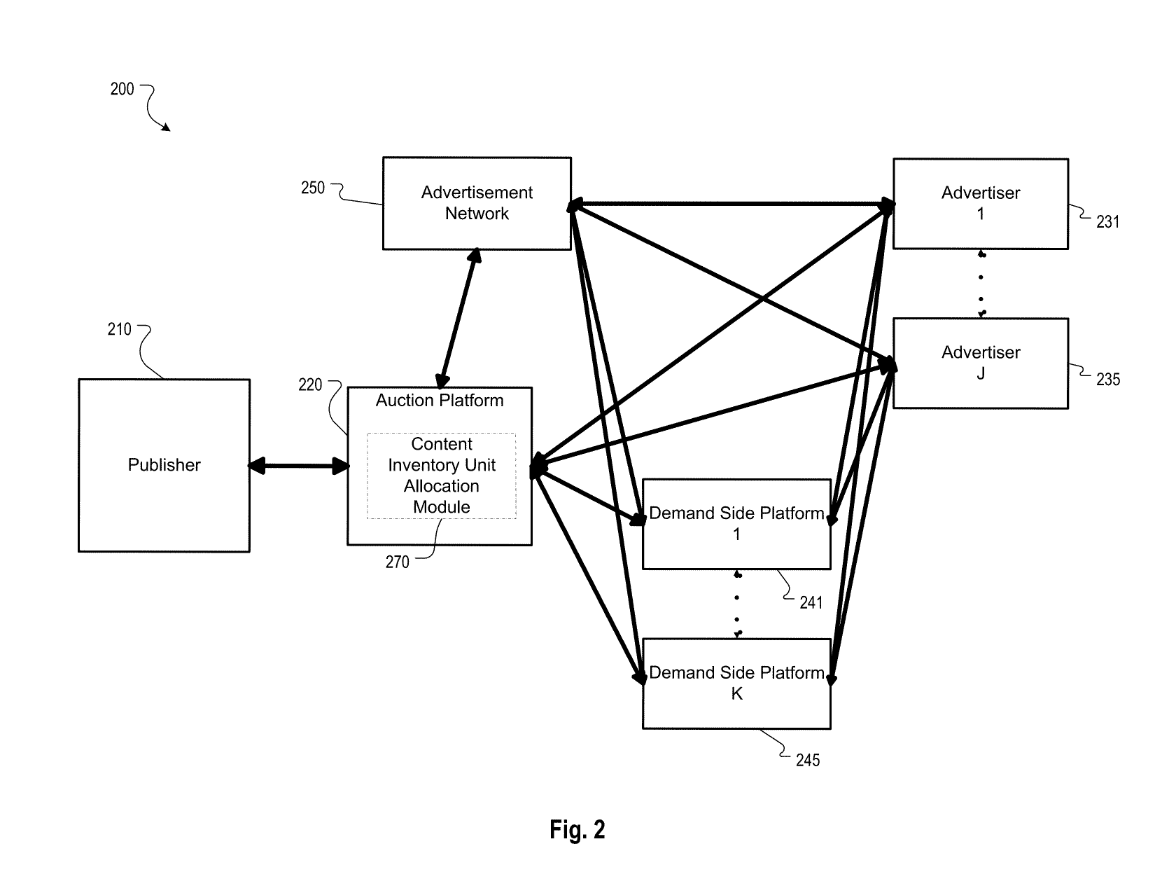

FIG. 2 is a block diagram of an example spot market for content inventory. The figure depicts the relationships between participants in the market. The lines in the figure represent transactions in which content inventory units are exchanged for content and revenue. Typically a content inventory unit, or information describing a content inventory unit, flows from left to right across the market via one or more transactions. In return a content item (e.g., an ad), or information concerning a content item, that will be served in the content inventory unit and revenue flow back to the publisher via the same transaction pathway.

A publisher 210 sells content inventory units to buyers. Usually, the publisher 210 allocates a content inventory unit through an MBB, such as auction platform 220. The MBB in turn sells the content inventory unit to a content provider (e.g., Advertiser 231 or 235) either directly or through another intermediary, such as a Demand-Side Platform (“DSP”) (e.g., DSP 241 or DSP 245). Content networks (e.g., advertisement network 250) may act as DSPs in some implementations. An MBB can conduct an auction for the content inventory unit, selling the content inventory unit to, for example, the highest bidder. The auction platform 220, for example, then provides a portion of the revenues from the sale to the publisher 210. The advertiser 231, for example, that ultimately buys the content inventory unit, gets to have one of its ads served or delivered to the user in the content inventory unit.

The auction platform 220 may use a content inventory unit allocation module 270 to implement an auction mechanism and allocate the content inventory unit in a systematic and efficient manner. For example, the content inventory unit allocation module 270 may determine a second reserve price based on the reserve price received from the publisher 210 and a difference between a highest sharing fraction and a lowest sharing fraction in a range of sharing fractions for the auction platform 220. The second reserve price may be used with an auction mechanism (e.g., a second-price auction mechanism) to allocate the content inventory unit to a winning buyer (e.g., advertiser 231) and determine the price paid by the buyer and the amount of these revenues that are to be paid to the publisher 210. An operator of the auction platform 220 may retain the remainder of the revenues and in this manner dynamically vary the sharing fraction for the auction platform 220 within the range. Dynamically varying the sharing fraction for the auction platform 220 may increase the number of content inventory units that are successfully allocated to buyers through the auction platform 220.

In some implementations, another market intermediary (e.g., advertisement network 250) may wish to dynamically vary its sharing fraction for content inventory unit allocations through the auction platform that the market intermediary facilitates (e.g., by submitting a bid for a content inventory unit on behalf of an advertiser or other buyer). For example, the auction platform 220 may enable advertisement network 250 to dynamically vary the sharing fraction for advertisement network 250 by modifying the processing of bids submitted by advertisement network 250 on behalf of potential buyers (e.g., advertiser 231 or advertiser 235).

In some implementations, content inventory unit allocation module 270 may determine a second reserve price based on a reserve price received from the publisher 210 and a difference between a highest sharing fraction and a lowest sharing fraction in a range of sharing fractions corresponding to the combined revenue share of the auction platform 220 and the advertisement network 250. Bids from the advertisement network 250 may be adjusted based on the highest sharing fraction in the range and the adjusted bid may be compared to the second reserve price. Other competing bids may be adjusted by different sharing ratios (e.g., a fixed sharing ratio for auction platform 220) that apply to those bids and these adjusted bids may be compared to a different reserve price (e.g., the reserve price declared by publisher 210). The content inventory unit may be allocated to the advertisement network 250 and its buyer if the adjusted advertisement network bid is above the second reserve price and either the adjusted advertisement network bid is the highest adjusted or all the other adjusted bids are below their respective reserve prices.

When content inventory unit allocation module 270 allocates a content inventory unit to advertisement network 150's buyer, the content inventory unit allocation module may also determine an amount paid by the buyer for the allocation based in part on the second reserve price. In some implementations, the allocation module 270 may determine an amount of revenue from the allocation that will be paid to the publisher 210, an amount that will be paid to an operator of auction platform 220 (e.g., based on a fixed sharing fraction for auction platform 220), and may determine that the remainder of the revenues will go to the advertisement network 250.

The content inventory unit allocation module 270 may record data regarding the transaction for accounting purposes or for use in updating distributions of bids and/or reserve prices. The information saved may include the reserve price received from the seller, the bids received, an identification of the buyer, and/or information about the content inventory unit, such as an identification of the content slot and the publisher, the time, or user characteristics. This transaction data may be stored directly in a record associated with a particular publisher or content slot. In some implementations, the information may be stored in a log of transactions that is processed periodically to update system parameters, such as distributions of bids and/or reserve prices.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

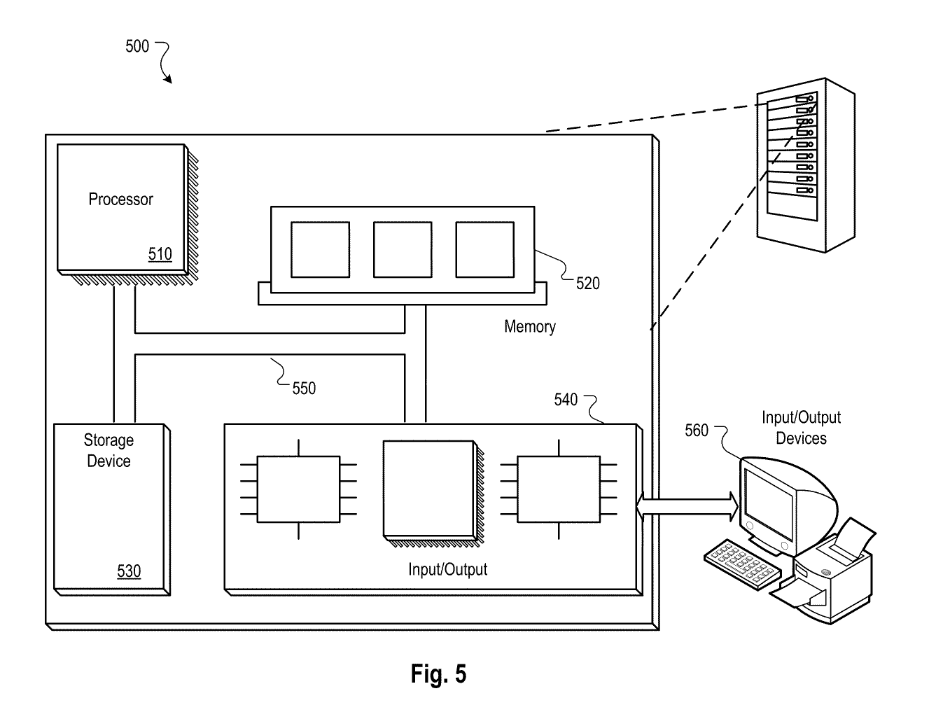

The content inventory unit allocation module 270 may be implemented in a variety of hardware and software configurations. For example, it may be implemented in software running on a dedicated processing system that is connected to a network, such as the Internet. The content inventory unit allocation module 270 may also be implemented in software that runs on a processing system utilized for other functionality, such as a web server 116 or an Ad server 110. In some implementations a content inventory unit allocation module 270 may run on a single processing device, such as the processing described below with reference to FIG. 5. In some implementations, a content inventory unit allocation module 270 may run on a on a multiple processing devices that communicate over a network and form a distributed computing system.

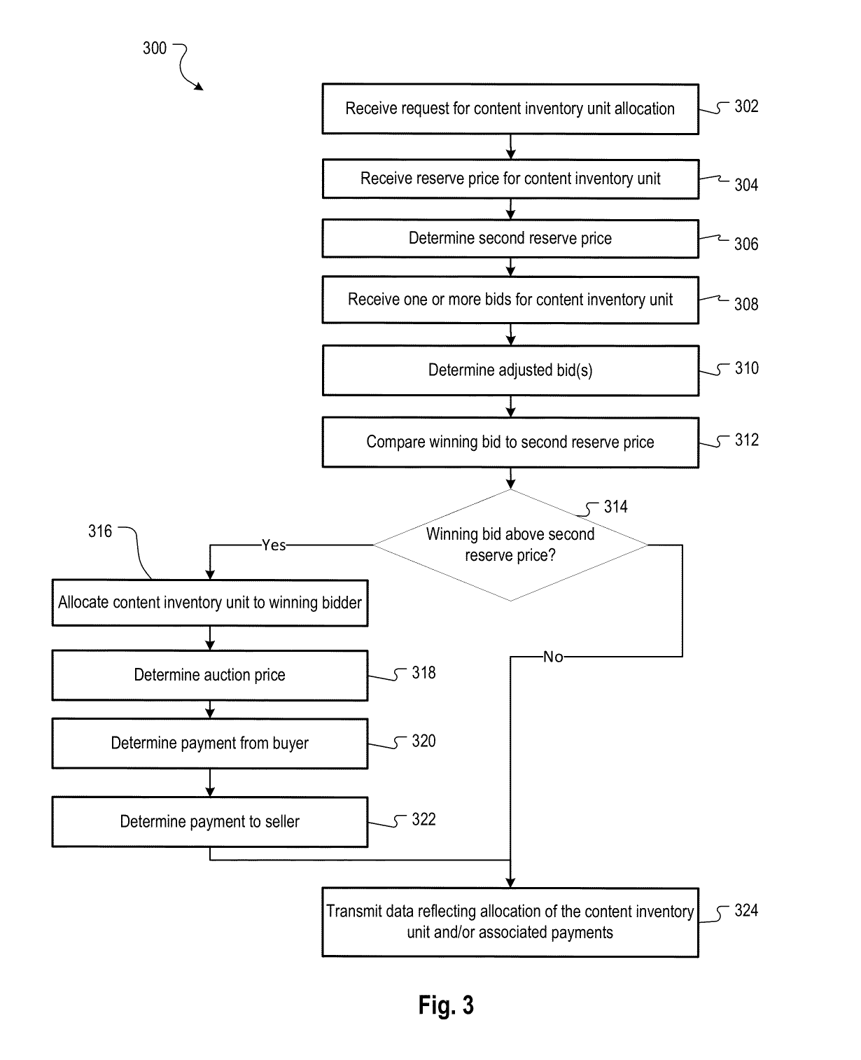

FIG. 3 is a flow chart of an example process 300 for allocating a content inventory unit to a buyer in response to a request. The content inventory unit allocation process 300 may be performed by the content inventory unit allocation module 270. Operations commence when the auction platform receives 302 a request for a content inventory unit to be allocated. For example, the request for content inventory unit allocation may be received from a publisher. In other examples, the request may be received from an advertisement management system, or directly from a user device requesting content including the content inventory unit, among other possible sources. The process 300 may be performed for each content inventory unit implicated by a user request for content. For example, the request may be received 302 through a network interface of the auction platform 220.

A reserve price is received 304 as part of the request or in a related communication. The reserve price may correspond to a minimum amount of revenue that will be accepted in exchange for the content inventory unit. In some implementations, the reserve price is declared by the publisher of the content in which the content slot of the content inventory unit occurs. The reserve price may be received from the publisher's server system or from another device associated with the request for allocation of the content inventory unit. For example, the reserve price may be received 304 through a network interface of the auction platform 220.

A second reserve price may be determined 306 based on the received reserve price and a range of sharing fractions for an auction platform. For example, the range of sharing fractions may be a range of acceptable sharing fractions for which the auction platform will process content inventory unit allocations. In some implementations, the lowest sharing fraction in the range may correspond to a minimum cost associated with operating the auction platform. The lowest sharing fraction may be determined based in part on this minimum cost associated with the auction platform. In some implementations, the highest sharing fraction in the range may be chosen in response to competition forces in the spot market for content inventory unit inventory (e.g., sharing fractions used by competing MBBs that a publisher may alternatively allocate its content inventory units through).

In some implementations, the second reserve price is determined based on the received reserve price and a difference between a highest sharing fraction and a lowest sharing fraction in the range of sharing fractions for an auction platform. For example, the second reserve price may be calculated as:

r′=r/(1−(λₕ−λₗ))

where r′ is the second reserve price, r is the received reserve price, λₕ is the highest sharing fraction in the range, and λₗ is the lowest sharing fraction in the range.

For example, the second reserve price may be determined 306 by the content inventory unit allocation module 270 of the auction platform 220.

One or more bids for the content inventory unit may be received 308 from prospective buyers (e.g., advertiser 231 or demand side platform 241). In some implementations, prospective buyers submit bids in response to auction announcement message from the auction platform 220. In some implementations, the auction announcement message includes an indication of the second reserve price. For example, the bids may be received 308 through a network interface of the auction platform 220.

One or more adjusted bids may be determined 310 based on received bids. For example, the adjusted bid(s) may be discounted for comparison to a reserve price to check that an allocation resulting from an auction with the adjusted bid(s) will result in an allocation that generates sufficient revenue for the both a publisher and an auction platform. In some implementations, the adjusted bids are determined 310 by discounting the received bid(s) by a factor that is based on the highest sharing fraction in the range of sharing fractions for the auction platform. For example, the adjusted bid(s) may be calculated according to:

b′ₙ=bₙ*(1−λₕ)

where b′ₙ is the adjusted bid for the nth potential buyer, bₙ is the received bid for the nth potential buyer, and λₕ is the highest sharing fraction in the range. For example, the adjusted bid(s) may be determined 310 by the content inventory unit allocation module 270 of the auction platform 220.

One or more of the adjusted bids may be compared 312 to the second reserve price. For example, a highest adjusted bid may be compared to the second reserve price to determine whether the content inventory unit will be allocated to a buyer by the auction platform. In some implementations, a second highest adjusted bid is compared to the second reserve price to determine the price that will be paid by the winning bidder, e.g., the buyer that submitted the highest bid. For example, the second reserve price may be compared 312 to one or more adjusted bids by the content inventory unit allocation module 270 of the auction platform 220.

If the winning bid is greater than the second reserve price 314, then the content inventory unit is allocated 316 to the buyer that submitted the winning bid. A content item (e.g., an advertisement) from the buyer (e.g., advertiser 231) or a subsequent purchaser will be served as the content inventory unit and, in exchange, the buyer will pay a price that may depend on the bids and/or the second reserve price. In some implementations, the content inventory unit is allocated to a buyer based on the results of a truthful auction. Data reflecting the allocation of the content inventory unit to the buyer and the price may be generated and stored in a data storage device. For example, the content inventory unit may be allocated 316 to a buyer by the content inventory unit allocation module 270 of the auction platform 220.

An auction price may be determined 318 based on the adjusted bid(s) and/or the second reserve price according to the rules of an auction mechanism (e.g., a second price auction mechanism). In some implementations, an auction price is determined 318 as a maximum of a set including the second reserve price and at least one of the one or more adjusted bids. For example, using a second-price auction mechanism, an auction price may be determined as a maximum of a set including the second reserve price and the one or more adjusted bids with the exception of a highest of the one or more adjusted bids. For example, an auction price may be determined 318 by the content inventory unit allocation module 270 of the auction platform 220.

The amount of a payment from the buyer may be determined 320. In some implementations, the amount of the payment from the buyer may be determined 320 based on the auction price and the highest sharing fraction. For example, the amount of the payment from the buyer may calculated as:

p_{b}=pₐ/(1−λₕ)

where p_{b} is the payment from the buyer, pₐ is the auction price. For example, the payment from the buyer may be determined 320 by the content inventory unit allocation module 270 of the auction platform 220.

The payment to the seller (e.g., the publisher) that will result from the allocation may also be determined 322. The payment to the seller may be determined 322 based on the first reserve price and the auction price. In some implementations, the payment to the seller is determined 322 as a maximum of the received reserve price and the auction price. The amount of revenue retained by the operator of the auction platform may also be determined. For example, the operator of the auction platform may receive the difference between the payment from the buyer and the payment to the seller as revenue. In some implementations, the amount of revenue retained by the operator of the auction platform corresponds to a sharing fraction within the range of sharing fractions associated with the auction platform. For example, the payment to the seller may be determined 322 by the content inventory unit allocation module 270 of the auction platform 220.

Data reflecting the allocation of the content inventory unit to the buyer may be transmitted 324. For example the data reflecting the allocation may be transmitted to the buyer (e.g., advertiser 231), the publisher (e.g., publisher 210 and/or webserver 116), and/or a user device (e.g., user device 102 running web browser 112). The data reflecting the allocation may include information identifying the buyer and the content inventory unit. In some implementations, the data reflecting the allocation may also include the price paid by the buyer, the revenue received by the seller, characteristics of the content inventory unit, and/or a content item that will be presented in the content inventory unit as a result of the allocation. In some implementations, information reflecting a content item supplied by the buyer is transmitted to a user device. In some implementations, the content item may be transmitted to the publisher who then relays the content to a user device. In some implementations, the publisher may only receive and relay a pointer to the content item, such as an address for the content item stored on a remote server run by the advertiser or another entity. In some implementations, an external device storing the content item may independently establish a communication with the user's access device based upon information supplied by the publisher with the description of the content inventory unit. Data reflecting the allocation of the content inventory unit may be transmitted in one or more messages over a network (e.g., network 107). For example, data reflecting the identification of the content inventory unit and the price to be paid by the buyer may be transmitted in a first message to the buyer, while data reflecting the revenues paid to the seller may be transmitted to the seller. For example, data reflecting the allocation of the content inventory unit to the buyer may be transmitted 324 through a network interface of the auction platform 220.

If the winning adjusted bid is less than the second reserve price 314, then the content inventory unit is not allocated to a buyer. Equivalently, the content inventory unit is allocated back to the seller (e.g., publisher 210). This result may be reflected in data transmitted 324 by auction platform through a network interface to inform the seller and/or any potential buyers that submitted bids.

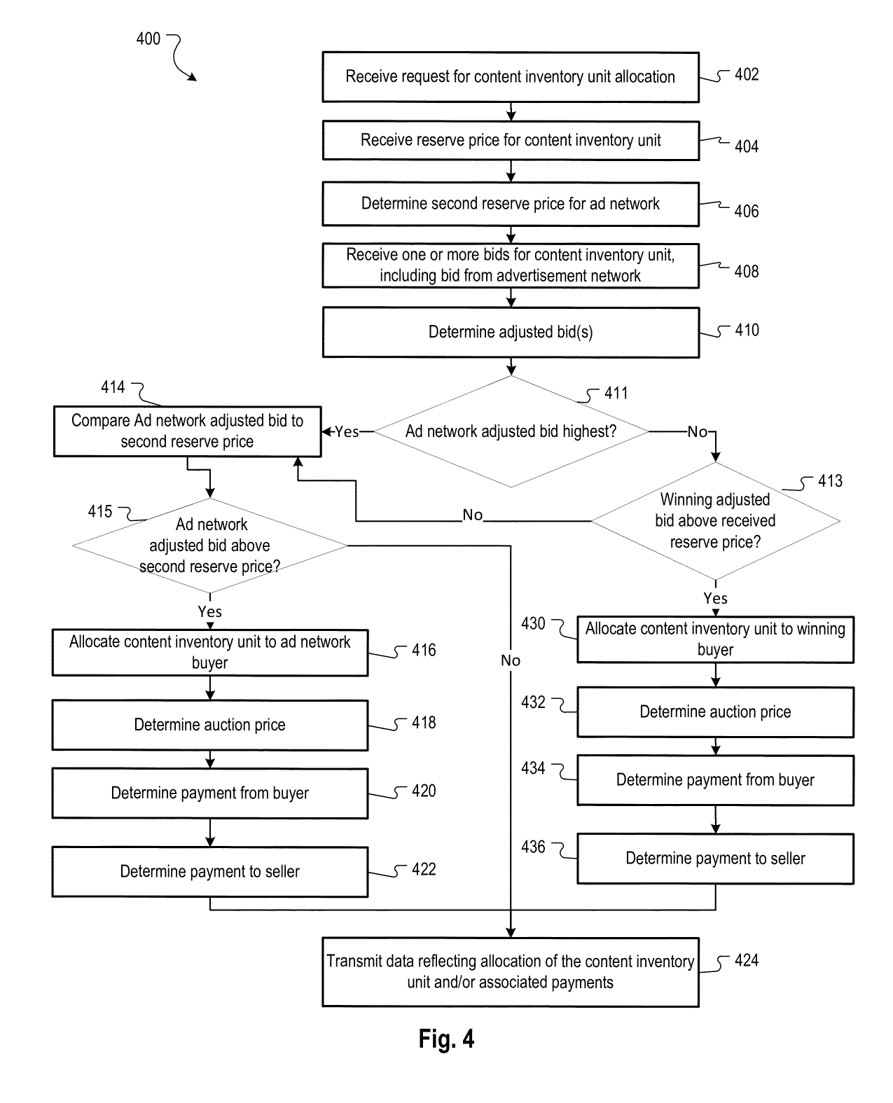

FIG. 4 is a flowchart of an example process 400 for allocating a content inventory unit to a buyer in response to a user request for content. Process 400 may allocate a content inventory unit in a manner that facilitates dynamic revenue sharing by a content inventory unit inventory spot market intermediary (e.g., an advertisement network). The content inventory unit allocation process 400 may be performed by the content inventory unit allocation module 270. Operations commence when the auction platform receives 402 a request for a content inventory unit to be allocated. For example, the request for content inventory unit allocation may be received from a publisher. In other examples, the request may be received from an advertisement management system, or directly from a user device requesting content including the content inventory unit, among other possible sources. The process 400 may be performed for each content inventory unit implicated by a user request for content. For example, the request may be received 402 through a network interface of the auction platform 220.

A reserve price is received 404 as part of the request or in a related communication. The reserve price may correspond to a minimum amount of revenue that will be accepted in exchange for the content inventory unit. In some implementations, the reserve price is declared by the publisher of the content in which the content slot of the content inventory unit occurs. The reserve price may be received from the publisher's server system or from another device associated with the request for allocation of the content inventory unit. For example, the reserve price may be received 404 through a network interface of the auction platform 220.

A second reserve price for an advertisement network may be determined 406 based on the received reserve price and a range of sharing fractions corresponding to a combined revenue share of an auction platform and an advertisement network. In some implementations, the range of sharing fractions may be based on a range of acceptable sharing fractions for which the advertisement network will process bids on content inventory units and on a constant sharing fraction for an auction platform. In some implementations, the lowest sharing fraction in the range may correspond to a minimum cost associated with operating the advertisement network. The lowest sharing fraction may be determined based in part on this minimum cost associated with the advertisement network. In some implementations, the highest sharing fraction in the range may be chosen in response to competition forces in the spot market for content inventory unit inventory (e.g., sharing fractions used by competing content inventory unit inventory spot market intermediaries that a buyer (e.g., an advertiser) may alternatively purchase content inventory units through). For example, if the advertisement network will accept sharing fraction in a range between 5% and 15% and the auction platform requires a 20% sharing fraction for itself, then the range of combined sharing fractions may be from a lowest value of 1−(1−0.2)(1−0.05)=24% to a highest value of 1−(1−0.2)(1−0.15)=32%.

In some implementations, the second reserve price for the advertisement network is determined based on the received reserve price and a difference between a highest sharing fraction and a lowest sharing fraction in a range of sharing fractions corresponding to a combined revenue share of an auction platform and an advertisement network. For example, the second reserve price may be calculated as:

r′=r/(1−(λₕ−λₗ))

where r′ is the second reserve price, r is the received reserve price, λₕ is the highest sharing fraction in the range of combined sharing fractions, and λₗ is the lowest sharing fraction in the range of combined sharing fractions. For example, the second reserve price may be determined 406 by the content inventory unit allocation module 270 of the auction platform 220.

One or more bids for the content inventory unit may be received 408 from prospective buyers (e.g., advertiser 231 or demand side platform 241), including at least a bid from the advertisement network. In some implementations, prospective buyers submit bids in response to auction announcement messages from the auction platform 220. In some implementations, the auction announcement messages include an indication of a reserve price applicable to a particular potential buyer (e.g., the second reserve price or the received reserve price). For example, the bids may be received 408 through a network interface of the auction platform 220.

One or more adjusted bids may be determined 410 based on received bids. For example, the adjusted bid(s) may be discounted for comparison to a reserve price to check that an allocation resulting from an auction with the adjusted bid(s) will result in an allocation that generates sufficient revenue for the both a publisher, an auction platform, and in some cases another market intermediary such as the advertisement network. In some implementations, the adjusted bid for the advertisement network is determined 310 by discounting the received bid by a factor that is based on the highest sharing fraction in the range of combined sharing fractions. For example, the adjusted bid may be calculated according to:

b′ₐₙ=bₐₙ*(1−λₕ)

where b′ₐₙ is the adjusted bid for the advertisement network, bₐₙ is the received bid for the advertisement network, and λₕ is the highest sharing fraction in the range of combined sharing fractions.

In some implementations, the adjusted bid(s) for other potential buyers may be determined 410 based in part on a sharing fraction applicable to those buyers respectively. For example, the adjusted bid(s) for other potential buyers may be determined by discounting the bid(s) by a factor that depends on the sharing fraction for the auction platform. For example, the adjusted bid(s) for other potential buyers may be calculated as:

b′ₙ=bₙ*(1−λ)

where b′ₙ is the adjusted bid for the nth potential buyer, bₙ is the received bid for the nth potential buyer, and λ is a constant sharing fraction for the auction platform (e.g., 20%). For example, the adjusted bid(s) may be determined 410 by the content inventory unit allocation module 270 of the auction platform 220.

If the advertisement network's adjusted bid is the highest adjusted bid 411 or if no other adjusted bid is above its respective applicable reserve price (e.g., the seller's declared reserve price) 413, then the advertising network's adjusted bid may be compared 414 to the second reserve price to determine whether the content inventory unit will be allocated to the advertisement network and the buyer on whose behalf it submitted its bid. In some implementations, a second highest adjusted bid is also compared to the second reserve price to determine the price that will be paid by the advertising network's buyer. For example, the second reserve price may be compared 414 to one or more adjusted bids by the content inventory unit allocation module 270 of the auction platform 220.

If the adjust bid from the advertisement network is greater than the second reserve price 415, then the content inventory unit is allocated 416 to the advertisement network and/or its buyer. A content item (e.g., an advertisement) from the buyer (e.g., advertiser 231) or a subsequent purchaser will be served in the content inventory unit and, in exchange, the buyer will pay a price that may depend on the bids and/or the second reserve price. In some implementations, the content inventory unit is allocated to a buyer based on the results of a truthful auction. Data reflecting the allocation of the content inventory unit to the buyer and the price may be generated and stored in a data storage device. For example, the content inventory unit may be allocated 416 to the advertisement network and/or its buyer by the content inventory unit allocation module 270 of the auction platform 220.

An auction price may be determined 418 based on the advertising network's adjusted bid and/or the second reserve price according to the rules of an auction mechanism (e.g., a second price auction mechanism). In some implementations, an auction price is determined 418 as a maximum of a set including the second reserve price and at least one of the one or more adjusted bids. For example, using a second-price auction mechanism, an auction price may be determined as a maximum of a set including the second reserve price and the adjusted bids of other potential buyers. For example, an auction price may be determined 418 by the content inventory unit allocation module 270 of the auction platform 220.

The amount of a payment from the buyer may be determined 420. In some implementations, the amount of the payment from the buyer may be determined 420 based on the auction price and the highest sharing fraction. For example, the amount of the payment from the buyer may be calculated as:

p_{b}=pₐ/(1−λₕ)

where p_{b} is the payment from the buyer, pₐ is the auction price, and λₕ is the highest sharing fraction in the range of combined sharing fractions. For example, the payment from the buyer may be determined 420 by the content inventory unit allocation module 270 of the auction platform 220.

The payment to the seller (e.g., the publisher) that will result from the allocation may also be determined 422. The payment to the seller may be determined 422 based on the received reserve price and the auction price. In some implementations, the payment to the seller is determined 422 as a maximum of the received reserve price and the auction price. The amount of revenue retained by the operator of the auction platform and the amount of revenue retained by the advertising network may also be determined. For example, the operator of the auction platform may receive the amount of the payment from to the seller multiplied by a sharing fraction for the auction platform divided by one minus the sharing fraction for the auction platform. For example, the operator of the advertisement network may receive the difference between the payment from the buyer and the sum of the payments to the seller and the operator of the auction platform. In some implementations, the amount of revenue retained by the operator of the advertisement network corresponds to a sharing fraction within a range of sharing fractions associated with the advertising network. For example, the payment to the seller may be determined 422 by the content inventory unit allocation module 270 of the auction platform 220.

Data reflecting the allocation of the content inventory unit to the buyer may be transmitted 424. For example the data reflecting the allocation may be transmitted to the buyer (e.g., advertising network 250 and/or advertiser 231), the publisher (e.g., publisher 210 and/or webserver 116), and/or a user device (e.g., user device 102 running web browser 112). The data reflecting the allocation may include information identifying the buyer and the content inventory unit. In some implementations, the data reflecting the allocation may also include the price paid by the buyer, the revenue received by the seller, characteristics of the content inventory unit, and/or a content item that will be presented in the content inventory unit as a result of the allocation. In some implementations, information reflecting a content item supplied by the buyer is transmitted to a user device. In some implementations, the content item may be transmitted to the publisher who then relays the content to a user device. In some implementations, the publisher may only receive and relay a pointer to the content item, such as an address for the content item stored on a remote server run by the advertiser or another entity. In some implementations, an external device storing the content item may independently establish a communication with the user's access device based upon information supplied by the publisher with the description of the content inventory unit. Data reflecting the allocation of the content inventory unit may be transmitted in one or more messages over a network (e.g., network 107). For example, data reflecting the identification of the content inventory unit and the price to be paid by the buyer may be transmitted in a first message to the buyer, while data reflecting the revenues paid to the seller may be transmitted to the seller. For example, data reflecting the allocation of the content inventory unit to the buyer may be transmitted 424 through a network interface of the auction platform 220.

If the adjusted bid from the advertising network is less than the second reserve price 415, then the content inventory unit is not allocated to a buyer. Equivalently, the content inventory unit is allocated back to the seller (e.g., publisher 210). This result may be reflected in data transmitted 424 by auction platform through a network interface to inform the seller and/or any potential buyers that submitted bids.

If the adjusted bid from the advertising network is not the highest adjusted bid 411 and the winning adjusted bid is above the reserve price applicable to that bid (e.g., the received reserve price) 413, then the content inventory unit may be allocated 430 to a buyer associated with the winning bid. In this case, the auction price may be determined 432 based on the reserve price applicable to that buyer (e.g., the received reserve price or some buyer specific reserve price) and one or more of the adjusted bids. For example, using a second-price auction mechanism, an auction price may be determined as a maximum of a set including the received reserve price and the one or more adjusted bids with the exception of a highest of the one or more adjusted bids. A payment from the buyer may be determined 434 based on the auction price and a sharing fraction applicable to that buyer. For example, the payment from the buyer may be calculated as the auction price divided by one minus the applicable sharing fraction (e.g., a constant sharing fraction of 20% for the auction platform). A payment to the seller may be determined 436 based on the auction price and/or the received reserve price. For example, the payment to the seller may be determined as the maximum of the received reserve price and the auction price. Data reflecting the allocation of the content inventory unit to the buyer may be transmitted 424 through a network interface of the auction platform 220.

FIG. 5 is block diagram of an example computer system 500 that can be used to allocate content inventory units. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 560.

The web server, advertisement server, and content inventory unit allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any claims or of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method performed by one or more data processing apparatus, the method comprising:
receiving a request for allocation of a content inventory unit;
receiving a first price for the content inventory unit, where the first price is a minimum payment that a seller will accept for allocation of the content inventory unit;
determining a second price based in part on the first price and based in part on a difference between a highest sharing fraction in a range and a lowest sharing fraction in the range;
receiving one or more bids for the content inventory unit;
determining one or more adjusted bids based on the one or more bids and the highest sharing fraction;
comparing at least one of the one or more adjusted bids to the second price;
allocating the content inventory unit to a buyer based in part on the one or more adjusted bids and the second price;
determining an auction price as a maximum of a set including the second price and at least one of the one or more adjusted bids;
determining a payment to the seller as a maximum of the first price and the auction price;
determining a payment from the buyer based on the auction price and the highest sharing fraction; and
transmitting data reflecting the allocation of the content inventory unit to the buyer.

2. The method of claim 1, wherein determining the second price comprises multiplying the first price by one minus the difference between the highest sharing fraction and the lowest sharing fraction.

3. The method of claim 1, wherein determining the one or more adjusted bids comprises multiplying the one or more bids by one minus the highest sharing fraction.

4. The method of claim 1, wherein the auction price is determined as a maximum of a set including the second price and the one or more adjusted bids with the exception of a highest of the one or more adjusted bids.

5. The method of claim 1, wherein determining the payment from the buyer comprises dividing the auction price by one minus the highest sharing fraction.

6. The method of claim 1, wherein the content inventory unit is allocated to the buyer based on the results of a truthful auction.

7. The method of claim 1, wherein the lowest sharing fraction is determined based in part on a minimum cost associated with an auction platform.

8. The method of claim 1, further comprising:
transmitting to a user device information reflecting a content item supplied by the buyer.

9. A method performed by one or more data processing apparatus, the method comprising:
receiving a request for allocation of a content inventory unit;
receiving a first price for the content inventory unit, where the first price is a minimum payment that a seller will accept for allocation of the content inventory unit;
determining a second price based in part on the first price and based in part on a difference between a highest sharing fraction in a range and a lowest sharing fraction in the range;
receiving a first bid for the content inventory unit;
determining a first adjusted bid based on the first bid and the highest sharing fraction;
comparing the first adjusted bid to the second price;
allocating the content inventory unit to a buyer based in part on the first adjusted bid and the second price;
determining an auction price based in part on the second price;
determining a payment to the seller as a maximum of the first price and the auction price;
determining a payment from the buyer based on the auction price and the highest sharing fraction; and
transmitting data reflecting the allocation of the content inventory unit to the buyer.

10. The method of claim 9, further comprising:
receiving one or more additional bids for the content inventory unit;
determining one or more additional adjusted bids based on the one or more additional bids and a first sharing fraction associated with the one or more additional bids; and
comparing the first adjusted auction price to the one or more additional adjusted auction prices.

11. The method of claim 10, wherein determining the auction price comprises determining a maximum of the second price and the one or more additional adjusted bids.

12. The method of claim 9, wherein the lowest sharing fraction is determined based in part on a fixed sharing fraction for an auction platform and further comprising:
determining a payment to an operator of the auction platform based on the fixed share fraction; and
determining a payment to a party that submitted one of the one or more bids on behalf of the buyer as the payment from the buyer minus the payment to the seller and the payment to the operator of the auction platform.

13. A system, comprising:
a data processing apparatus; and
a memory coupled to the data processing apparatus having instructions stored thereon which, when executed by the data processing apparatus cause the data processing apparatus to perform operations comprising:
receiving a request for allocation of a content inventory unit;
receiving a first price for the content inventory unit, where the first price is a minimum payment that a seller will accept for allocation of the content inventory unit;
determining a second price based in part on the first price and based in part on a difference between a highest sharing fraction in a range and a lowest sharing fraction in the range;
receiving one or more bids for the content inventory unit;
determining one or more adjusted bids based on the one or more bids and the highest sharing fraction;
comparing at least one of the one or more adjusted bids to the second price;
allocating the content inventory unit to a buyer based in part on the one or more adjusted bids and the second price;
determining an auction price as a maximum of a set including the second price and at least one of the one or more adjusted bids;
determining a payment to the seller as a maximum of the first price and the auction price;
determining a payment from the buyer based on the auction price and the highest sharing fraction; and
transmitting data reflecting the allocation of the content inventory unit to the buyer.

14. The system of claim 13, wherein determining the second price comprises multiplying the first price by one minus the difference between the highest sharing fraction and the lowest sharing fraction.

15. The system of claim 13, wherein determining the one or more adjusted bids comprises multiplying the one or more bids by one minus the highest sharing fraction.

16. The system of claim 13, wherein the auction price is determined as a maximum of a set including the second price and the one or more adjusted bids with the exception of a highest of the one or more adjusted bids.

17. The system of claim 13, wherein determining the payment from the buyer comprises dividing the auction price by one minus the highest sharing fraction.

18. The system of claim 13, wherein the content inventory unit is allocated to the buyer based on the results of a truthful auction.

19. The system of claim 13, wherein the lowest sharing fraction is determined based in part on a minimum cost associated with an auction platform.

20. The system of claim 13, where in the operations further comprise:
transmitting to a user device information reflecting a content item supplied by the buyer.

21. A system, comprising:
a network interface configured to receive a request for allocation of a content inventory unit;
a network interface configured to receive a first price for the content inventory unit, where the first price is a minimum payment that a seller will accept for allocation of the content inventory unit;
a means for determining a second price based in part on the first price and based in part on a difference between a highest sharing fraction in a range and a lowest sharing fraction in the range;
a network interface configured to receive one or more bids for the content inventory unit;
a module configured to determine one or more adjusted bids based on the one or more bids and the highest sharing fraction;
a module configured to comparing at least one of the one or more adjusted bids to the second price;
a module configured to allocate the content inventory unit to a buyer based in part on the one or more adjusted bids and the second price;
a module configured to determine an auction price as a maximum of a set including the second price and at least one of the one or more adjusted bids;
a module configured to determine a payment to the seller as a maximum of the first price and the auction price;
a module configured to determine a payment from the buyer based on the auction price and the highest sharing fraction; and
a network interface configured to transmit data reflecting the allocation of the content inventory unit to the buyer.

22. The system of claim 21, wherein determining the one or more adjusted bids comprises multiplying the one or more bids by one minus the highest sharing fraction.

23. The system of claim 21, wherein the auction price is determined as a maximum of a set including the second price and the one or more adjusted bids with the exception of a highest of the one or more adjusted bids.

24. The system of claim 21, wherein determining the payment from the buyer comprises dividing the auction price by one minus the highest sharing fraction.

25. The system of claim 21, wherein the content inventory unit is allocated to the buyer based on the results of a truthful auction.

26. The system of claim 21, wherein the lowest sharing fraction is determined based in part on a minimum cost associated with an auction platform.

27. The system of claim 21, comprising:
a network interface configured to transmit to a user device information reflecting a content item supplied by the buyer.

28. A system, comprising:
a data processing apparatus; and
a memory coupled to the data processing apparatus having instructions stored thereon which, when executed by the data processing apparatus cause the data processing apparatus to perform operations comprising:
receiving a request for allocation of a content inventory unit;
receiving a first price for the content inventory unit, where the first price is a minimum payment that a seller will accept for allocation of the content inventory unit;
determining a second price based in part on the first price and based in part on a difference between a highest sharing fraction in a range and a lowest sharing fraction in the range;
receiving a first bid for the content inventory unit;
determining a first adjusted bid based on the first bid and the highest sharing fraction;
comparing the first adjusted bid to the second price;
allocating the content inventory unit to a buyer based in part on the first adjusted bid and the second price;
determining an auction price based in part on the second price;
determining a payment to the seller as a maximum of the first price and the auction price;
determining a payment from the buyer based on the auction price and the highest sharing fraction; and
transmitting data reflecting the allocation of the content inventory unit to the buyer.

29. The system of claim 28, wherein the operations further comprise:
receiving one or more additional bids for the content inventory unit;
determining one or more additional adjusted bids based on the one or more additional bids and a first sharing fraction associated with the one or more additional bids; and
comparing the first adjusted auction price to the one or more additional adjusted auction prices.

30. The system of claim 29, wherein determining the auction price comprises determining a maximum of the second price and the one or more additional adjusted bids.

31. The system of claim 28, wherein the lowest sharing fraction is determined based in part on a fixed sharing fraction for an auction platform and wherein the operations further comprise:
determining a payment to an operator of the auction platform based on the fixed share fraction; and
determining a payment to a party that submitted one of the one or more bids on behalf of the buyer as the payment from the buyer minus the payment to the seller and the payment to the operator of the auction platform.

32. A system comprising:
a network interface configured to receive a request for allocation of a content inventory unit;
a network interface configured to receive a first price for the content inventory unit, where the first price is a minimum payment that a seller will accept for allocation of the content inventory unit;
a means for determining a second price based in part on the first price and based in part on a difference between a highest sharing fraction in a range and a lowest sharing fraction in the range;
a network interface configured to receive a first bid for the content inventory unit;
a module configured to determine a first adjusted bid based on the first bid and the highest sharing fraction;
a module configured to compare the first adjusted bid to the second price;
a module configured to allocate the content inventory unit to a buyer based in part on the first adjusted bid and the second price;
a module configured to determine an auction price based in part on the second price;
a module configured to determine a payment to the seller as a maximum of the first price and the auction price;
a module configured to determine a payment from the buyer based on the auction price and the highest sharing fraction; and
a network interface configured to transmit data reflecting the allocation of the content inventory unit to the buyer.

33. The system of claim 32, comprising:
a network interface configured to receive one or more additional bids for the content inventory unit;
a module configured to determine one or more additional adjusted bids based on the one or more additional bids and a first sharing fraction associated with the one or more additional bids; and
a module configured to compare the first adjusted auction price to the one or more additional adjusted auction prices.

34. The system of claim 33, wherein determining the auction price comprises determining a maximum of the second price and the one or more additional adjusted bids.

35. The system of claim 32, wherein the lowest sharing fraction is determined based in part on a fixed sharing fraction for an auction platform and comprising:
a module configured to determine a payment to an operator of the auction platform based on the fixed share fraction; and
a module configured to determine a payment to a party that submitted one of the one or more bids on behalf of the buyer as the payment from the buyer minus the payment to the seller and the payment to the operator of the auction platform.
